(19) United States
(12) Patent Application Publication
(10) Pub. No.: US 2024/0430850 A1
(43) Pub. Date: Dec. 26, 2024

(54) ROUND TRIP TIME-BASED USER EQUIPMENT POSITIONING CORRECTION AT TRANSMIT-RECEIVE POINTS FOR MULTIPLE-ROUND TRIP TIME-BASED USER EQUIPMENT LOCATION ESTIMATION

(71) Applicant: Dell Products L.P., Round Rock, TX (US)

(72) Inventors: Evgeny Paltin, Montreal (CA); Gwenael Poitau, Montreal (CA); Hamidreza Farmanbar, Ottawa (CA)

(21) Appl. No.: 18/340,998

(22) Filed: Jun. 26, 2023

(51) Int. Cl. H04W 64/00; H04L 43/0864

(52) U.S. Cl. CPC H04W 64/003; H04L 43/0864

(57) ABSTRACT

The technology described herein is directed towards obtaining an estimated location of user equipment, based on measured round trip time data and angle of arrival data to correct the measured round trip time data into virtual round trip time data, including for non-line of sight communication links from an unknown location of a user equipment and a transmit-receive point in an environment. The virtual round trip time data obtained from transmit-receive points is combined into a vector dataset input to a line of sight-based position determination/calculation function to obtain the estimated user equipment location. Correction can be per transmit-receive point, e.g., via a trained AI/ML (artificial intelligence/machine learning) model for the transmit-receive point, analytical function or lookup table-based correction module.

### BACKGROUND

In new radio (NR), the third generation partnership project (3GPP) standard facilitates the collection of measurements needed to implement a multiple point round trip time positioning algorithm to determine the location of a user equipment (UE). This algorithm has a significant drawback, mainly because of its reliance on line-of-sight conditions between multiple transmit-receive points and a user equipment (UE). Even when most of the links between the transmit-receive points and a UE are line-of-sight links, even a single non-line of sight link can cause outsized degradation of the position determination.

Another approach is a channel impulse response (CIR)-based direct AI/ML (artificial intelligence/machine learning) approach, which avoids the line-of-sight dependency by having an AI/ML model find a relationship between CIR data and a position coordinate; (this approach is called ‘Direct’ because it maps directly between the CIR and location coordinates without trying to model the process). However, the CIR-based direct AI/ML approach is very impractical in most scenarios because of being sensitive to the slightest variations manifested in the perceived CIR. More particularly, one of the most significant CIR-related variations is a clock instability, which can correspond to loose timing synchronization between transmit-receive points. When a clock drifts, the perceived time of arrival is incorrect and channel taps phase rotate, resulting in incorrect CIR data. CIR-based direct AI/ML algorithms thus require very tight network synchronization. One solution attempts to include virtually all of the targeted conditions in the training dataset; for clock-related issues, this means attempting to generate a training dataset with virtually all possible variations of clock behaviors among multiple transmit-receive points and a UE. Such a solution is not practical for real system deployments.

### BRIEF DESCRIPTION OF THE DRAWINGS

The technology described herein is illustrated by way of example and not limited in the accompanying figures in which like reference numerals indicate similar elements and in which:

FIG. 1 depicts an example block diagram representation of a system/architecture in which an artificial intelligence/machine learning (AI/ML) model corrects round trip time data for non-line of sight communications, for estimation of a location of a user equipment, in accordance with various aspects and implementations of the subject disclosure.

FIG. 2 shows example representations of round trip time data for line of sight and non-line of sight communication links, in accordance with various aspects and implementations of the subject disclosure.

FIG. 3 shows an example representation of round trip time data for a non-line of sight communication link, and the concept of modifying the round trip time data based on a virtual line of sight communication link, in accordance with various aspects and implementations of the subject disclosure.

FIG. 4 shows an example representation of an AI/ML model that corrects non-line of sight round-trip time data, such as shown in FIG. 3, to virtual line of sight round-trip time data, in accordance with various aspects and implementations of the subject disclosure.

FIG. 5 is an example visual representation of round trip time correction for given round trip time input, in which the circle represents the possible locations of user equipment that can result in the same round trip time measurement in line of sight conditions in accordance with various aspects and implementations of the subject disclosure.

FIG. 6 is an example representation of a multiple (multi)-positioning (e.g., triangulation) scheme in which line-of sight (LOS) measured round trip time data (with no significant correction) and virtual line-of sight (“LOS-like”) round trip time data, determined from measured round trip time data and angle of arrival data, are used to estimate a position of a user equipment, in accordance with various aspects and implementations of the subject disclosure.

FIG. 7 is an example representation of a deployment area with round trip time model training data obtained from positioning reference unit (PRU) device instances and transmit-receive points (TRPs), and thereafter how a user equipment location can be estimated by a correction model that has been trained with the training data, in accordance with various aspects and implementations of the subject disclosure.

FIG. 8 is an example representation of a deployment area in which a user equipment's location can be estimated by a trained model based on line-of sight round trip time data and virtual line-of sight round trip time data obtained from measured communications between transmit-receive points and the user equipment, in accordance with various aspects and implementations of the subject disclosure.

FIG. 9 is a flow diagram showing example operations related to modifying round trip time data, based on angle of arrival data, to obtain virtual line of sight round trip time data for use in estimating a location of a user equipment, in accordance with various aspects and implementations of the subject disclosure.

FIG. 10 is a flow diagram showing example operations related to modification, by a model based on the round trip time data and angle of arrival data, measured round trip time data for a non-line of sight communication into virtual line of sight round trip time data, in accordance with various aspects and implementations of the subject disclosure.

FIGS. 11 and 12 comprise a flow diagram showing example operations related to combining virtual round trip time data, obtained from transmit-receive point models based on angle of arrival data and measured round trip data, into a vector dataset for obtaining an estimated location of user equipment, in accordance with various aspects and implementations of the subject disclosure.

FIG. 13 is a block diagram representing an example computing environment into which aspects of the subject matter described herein may be incorporated.

FIG. 14 depicts an example schematic block diagram of a computing environment with which the disclosed subject matter can interact/be implemented at least in part, in accordance with various aspects and implementations of the subject disclosure.

### DETAILED DESCRIPTION

Various aspects of the technology described herein are generally directed towards having a transmit-receive point-based correction module (e.g., a trained artificial intelligence/machine learning (AI/ML) model, a lookup table-based module and/or an analytical function-based module) obtain round-trip time data and angle of arrival data with respect to a transmit-receive point and user equipment communication. Based on the round-trip time data and angle of arrival data, the transmit-receive point can correct the round-trip time data for non-line of sight communications into virtual (line of sight, or “LOS-like”) round-trip time data. This data is combined with round-trip time data from other transmit-receive points, which similarly may be corrected for non-line of sight communications, into a vector dataset. The vector dataset including virtual round trip time data is input to a line of sight-based position determination (calculation) function, such as one of those already defined, which for an otherwise unknown location of a user equipment can then estimate the location of the user equipment (e.g., as location coordinates [x, y] or [x, y, z]) to a sufficient estimation accuracy. Significantly, given combinations of line of sight and non-line of sight communication links, the correction module can correct/modify any non-line of sight round trip time data into virtual “LOS-like” round trip time data.

If the correction module is an artificial intelligence/machine learning (AI/ML) model, training is per transmit-receive point, that is each deployed transmit-receive point has a model trained for that transmit-receive point. Training is based on labeled training data corresponding to a number of device training instances (e.g., a device group) at known locations, with measured round trip time data and angle of arrival data obtained via communications between the transmit-receive points and each of the device training instances.

As is understood, the round trip time a for a non-line of sight communication is longer than the round trip time a line of sight communication. The angle of arrival data may or may not be close to the angle of arrival data for a line of sight link. However, in training the combination of round trip time data and angle of arrival data along with the training device instance location allows the model to learn how to correct non-line of sight round trip times into virtual round trip times.

In this way, for user equipment at an unknown location, once trained the model can obtain and correct non-line of sight round trip time data into virtual “LOS-like” round trip time data. With similar round trip time data from other transmit-receive points, a vector dataset including the model's post-modified corrected non-line of sight round trip time value, along with other corrected non-line of sight round trip time data (which can be unmodified or substantially unmodified for measured line of sight round trip communications), can be input into the position determination function as if all values were measured line of sight round trip times, to obtain an estimated location of the user equipment.

Reference throughout this specification to “one embodiment,” “an embodiment,” “one implementation,” “an implementation,” etc. means that a particular feature, structure, or characteristic described in connection with the embodiment/implementation is included in at least one embodiment/implementation. Thus, the appearances of such a phrase “in one embodiment,” “in an implementation,” etc. in various places throughout this specification are not necessarily all referring to the same embodiment/implementation. Furthermore, the particular features, structures, or characteristics may be combined in any suitable manner in one or more embodiments/implementations.

Aspects of the subject disclosure will now be described more fully hereinafter with reference to the accompanying drawings in which example components, graphs and/or operations are shown. In the following description, for purposes of explanation, numerous specific details are set forth in order to provide a thorough understanding of the various embodiments. However, the subject disclosure may be embodied in many different forms and should not be construed as limited to the examples set forth herein.

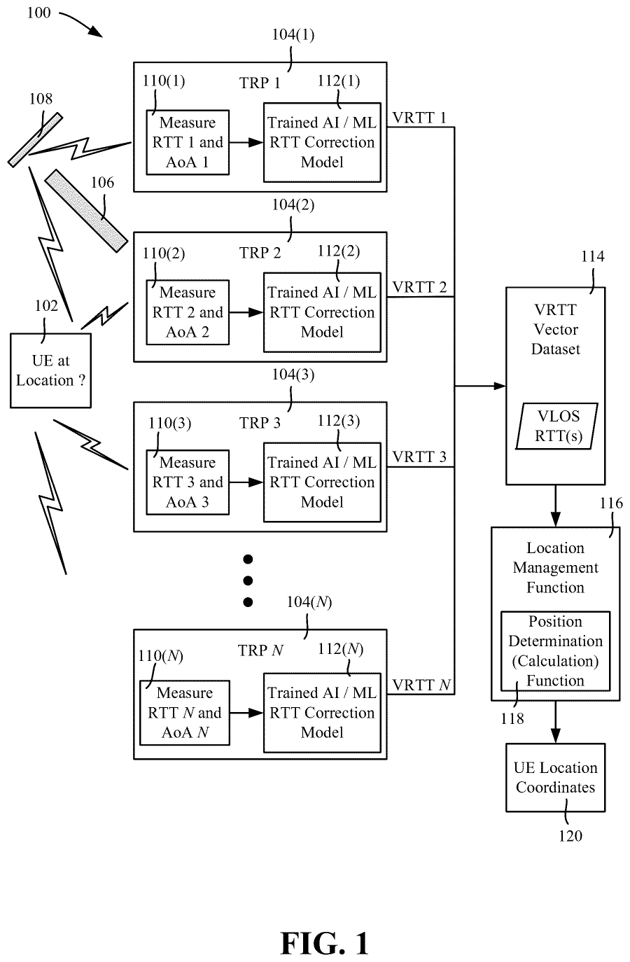

FIG. 1 is an example representation of a system/architecture 100 in which user equipment 102 at an unknown location communicates with a number of transmit-receive points (TRPs) 104(1)-104(N) deployed in an environment. As can be seen, at least the communication between the user equipment 102 and the transmit-receive point 104(1) (TRP 1) does not correspond to a line of sight measurement, as any direct communication link is blocked by an obstacle 106, whereby the measurement communication link is indirect, obtained as non-line of sight data off of some reflective surface 108.

In FIG. 1, respective transmit-receive points 104(1)-104(N) measure respective round trip times RTT1-RTTN and respective angle of arrival data AoA1-AoAN from the user equipment 102, shown as respective blocks 110(1)-110(N). The respective transmit-receive points 104(1)-104(N) in the example of FIG. 1 include correction modules, which in this example are respective trained AI/ML round trip time (RTT) correction models 112(1)-112(N). Note that the correction models 112(1)-112(N) are trained per transmit-receive point, and shown as being incorporated into the transmit-receive points. As can be readily appreciated, alternative implementations can have external correction models, e.g., as separate component(s) following the transmit-receive points but prior to any line of sight-based position determination.

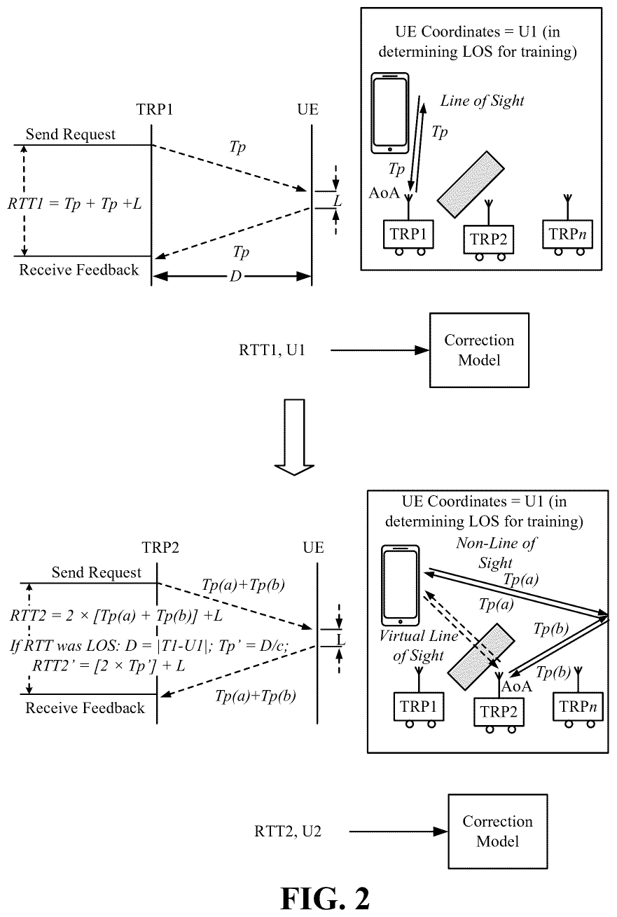

The output of the correction models 112(1)-112(N) results in a number of virtual round trip times VRTT1-VRTTN being determined by the transmit-receive points 104(1)-104(N), as further described in FIGS. 2-4. These can be combined into a VRTT vector dataset 114, which is input to a location management function 116 that includes a position determination (calculation) function 118, which is configured to process line-of-sight round trip time data into an estimated location (e.g., UE coordinates 120) of the user equipment 102. As can be readily appreciated, the amount of training data along with the fidelity of the training data (e.g., how accurate are the training devices' locations and measured round trip times) determine the correction accuracy and thus how closely the UE's estimated location coordinates are to the UE's actual location.

It should be noted that once trained, the model does not differentiate between line of sight communication links and non-line of sight communication links, as the model has learned the relation between an input measured round trip time and angle of arrival, and the virtual, line of sight-associated round trip time. Note however that the module can make a slight correction even for a line of sight communication link, e.g., because a measured round trip time value or angle of arrival may be inaccurate based on imperfect resolution of device or device's coordinates, timing measurements and/or latency data. In any event, as used herein, “virtual round trip time” (VRTT) data as output by the model can be corrected RTT data, negligibly corrected RTT data or not corrected at all.

FIG. 2 shows the concept of round trip times for line of sight communication links and non-line of sight communication links. For a line of sight communication link, as shown in the upper portion of FIG. 2, a transmit receive point (TRP) sends a request to a user equipment (UE), which is received and responded to by the UE by a transmission back to the TRP. The propagation time Tₚ taken to transmit from the TRP1 and receive at the UE, and vice versa is based on the distance D, that is, D=Tₚ·c, where c is the speed of light. There is some latency, L, at the UE between reception and the return transmission, and thus RTT1=Tₚ+Tₚ+L based on

$${T}_{p} = \frac{( R T T - L )}{2} .$$

Timestamps or the like associated with each transmission can be used to determine the latency. In training, the coordinates U1 of each UE device instance (which can be a positioning reference unit such as described in the third generation partnership, or 3GPP standards) are known and can be used to determine the “expected” line of sight round trip time/angle of arrival in the training data, along with the RTT1 value and the angle of arrival data detected by TRP1. During inference after training, the UE coordinates are unknown, and thus the RTT1 data and angle of arrival data AoA are used to determine the VRTT that becomes part of the modified round trip time vector dataset used to estimate the UE coordinates.

The lower portion of FIG. 2 shows the concept of a round trip time for a non-line of sight communication link. In this example, the transmit-receive point (TRP2) sends a request to the user equipment (UE), which is received and responded to by the UE by a transmission back to the TRP2. Each total propagation time taken to transmit from the TRP1 and receive at the UE, and vice versa is based on the indirect links, shown as propagation times Tp(a) and Tp(b). Again, there is some latency, L, taken by at the UE between reception and the return transmission, and thus RTT2=2×[Tₚ(a)+Tₚ(b)]+L. In training, because the UE's coordinates U1 were known, the expected line of sight time (acting as if there was line of sight) can be determined and used in the training data along with the measured RTT2 value and the angle of arrival data AoA; in inference, the UE coordinates are unknown, and thus the measured RTT2 value associated with the TRP2 and the angle of arrival data AoA is used to determine the VRTT that becomes part of the round trip time vector dataset that is then used to estimate the UE coordinates.

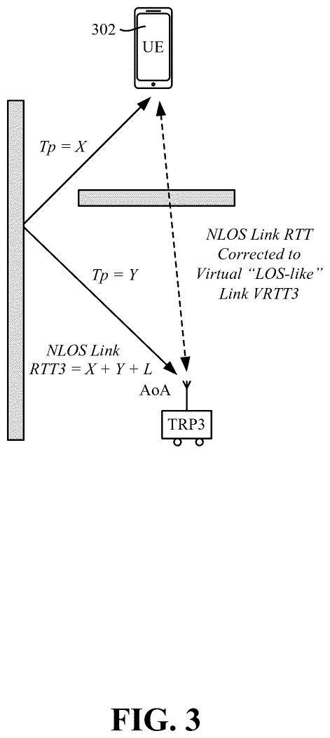

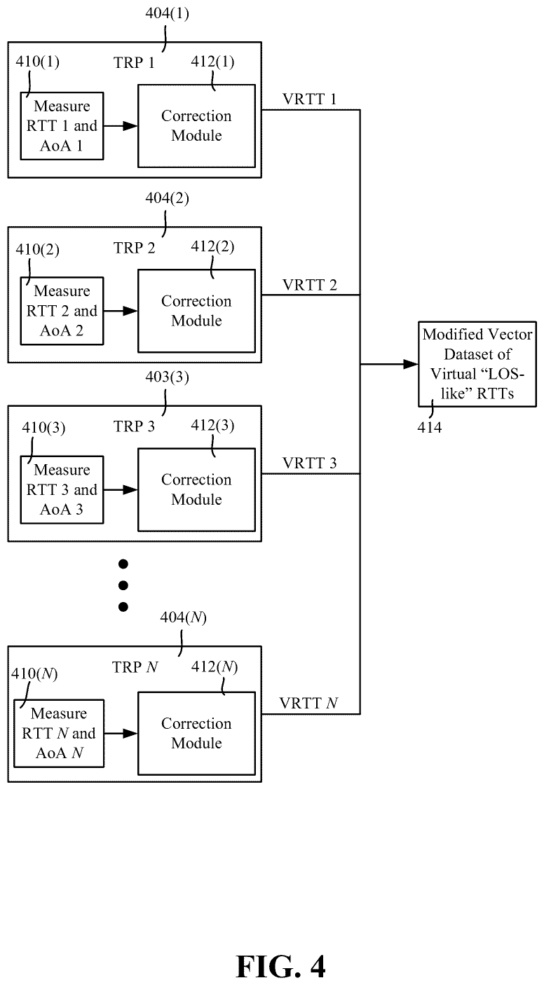

FIG. 3 shows a similar example in which an indirect, non-line of sight round trip time of RTT3 (based on the combined distance/propagation times of X+Y (plus latency L)) and angle of arrival data AoA between a UE 302 and a transmit-receive point TRP3 is used to correct the RTTT3 value to a virtual line of sight “LOS-like” VRTT3. As shown in FIG. 4, this RTT data and angle of arrival data AoA is input to the correction module (e.g., a trained AI/ML RTT correction model 412(3)), with the output becoming part of the vector dataset 414 that will be used to determine the UE location coordinates.

Implementation of the RTT correction functionality can take different forms, including, but not limited to an AI/ML model, lookup table or analytical functions; a combination of these forms can be used. Some interpolation may be used for input angles and/or times that are between saved lookup table values, for example. The selected form can depend on implementation considerations such as accuracy objective, dynamic range and granularity of the input values, processing time requirements, memory consumption AI/ML hardware accelerator availability, and so on. For purposes of description, a correction module that incorporates or is coupled to an AI/ML model is generally described herein in the examples, although as is understood any examples described herein are not limited to AI/ML models.

If an AI/ML based approach is chosen, a separate model needs to be trained for each TRP because the associated function is unique to each location as described herein. In alternative types of modules, it may be beneficial to have a separate lookup tables and/or separate functions for purposes of efficient parallel processing, rather than have one larger lookup table and/or analytical functions that processes the input data for the various TRPs.

Different AI/ML regression solutions can be considered depending on system requirements and platform capabilities. Models can include, but are not limited to classical tools such as polynomial regression models, as well as deep neural network (DNN) models. In the event the environment changes, reinforcement learning can be employed to maintain a model's relevance over time.

In any event, instead of inputting measured round trip times into a multi-RTT algorithm (e.g., the position determination (calculation) function 118 of FIG. 1), a correction module/component is implemented in (or just after) a TRP after signal measurements are collected. The utilized measurements are measured RTT data and angle of arrival (AoA) data (azimuth and elevation values for three dimensions or azimuth for two dimensions) and which are the inputs to the correction module. The corrected output is a VRTT value, which is associated with virtual LOS-like link. The central location function (location managing function, LMF in 3GPP) in the network does not have to be aware of the modified round trip time resulting from the TRP functionality change.

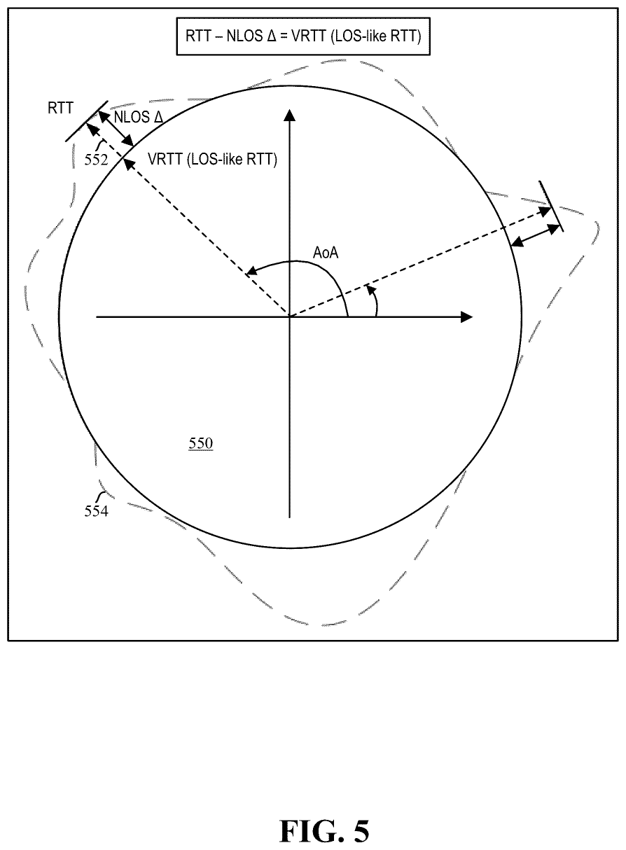

FIG. 5 illustrates how the RTT correction is made by exploiting the relationship between the measured signal RTT and AoA; (for simplicity the FIG. 5 example is for azimuth angle only). In FIG. 5, the circle 550 represents all the possible locations of UE that would result in the same RTT measurement in LOS conditions. Intuitively, the minimal propagation time is associated with LOS conditions. An NLOS condition results in increased propagation time which is represented by the dashed arrow 552 to the outlined polygon 554 (e.g., the deployment environment) surrounding the circle's solid line, corresponding to some extra propagation time (“NLOS Δ”). The gap between the solid and dashed lines changes depending on the angle of arrival. This relation between the RTT (based on the radius in FIG. 5) and the angle AoA is expected to be deployment-specific, and different for each TRP. The functionality implemented by the introduced component subtracts the NLOS-associated increase, which depends on the measured RTT and AoA pair.

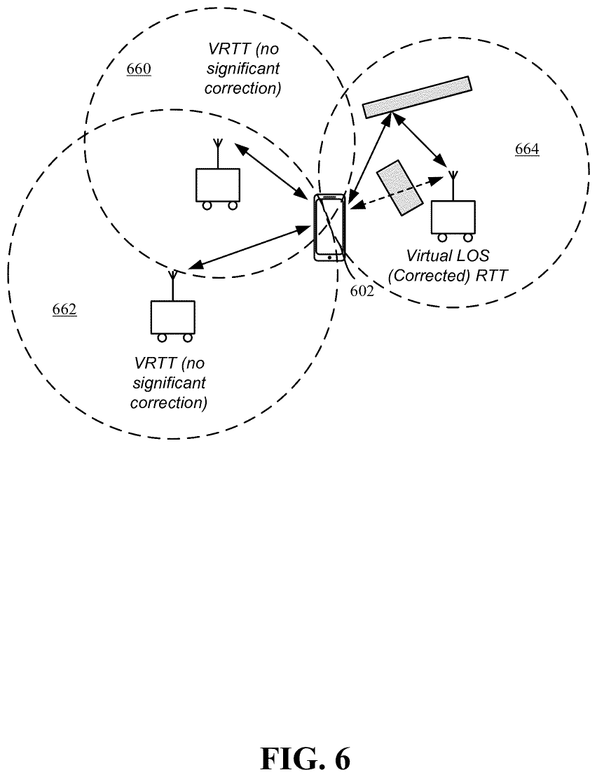

FIG. 6 shows the multi-RTT determination (two-dimensional triangulation in this example) of a location of a UE 602, based on translated RTT measurements from multiple base stations/transmit-receive points (TRPs). Multi-RTT determination is based upon an assumption of line of sight conditions between TRPs and a UE, which enables interpreting measured propagation delay to a distance. Without directional information, the distance can be translated into a circle representing possible locations of a UE. With additional directional information, the circle can be reduced to an arc.

Once the correction is made, as can be seen in the example of FIG. 6, each virtual round trip time (VRTT) corresponds to circles 660, 662 and 664 (or alternatively arcs) of a potential UE location. In FIG. 6, the circles 660 and 662 are line of sight-based measurements, and thus the VRRT is the measured RTT, or some negligibly corrected value thereof as described herein. The most significant correction is for the virtual line of sight RTT measurement represented by circle 664 (or alternatively another arc). Based on their intersections, the position determination function calculates an estimate of the UE's position. Note that without the correction to a virtual line of sight distance/VRTT, the circle 664 would be based on the longer non-line of sight propagation time, and thus in the wrong location (relative to the UE 402 and relative to the line of sight-based circles 660 and 662), whereby the intersection would not be at the UE's actual coordinates.

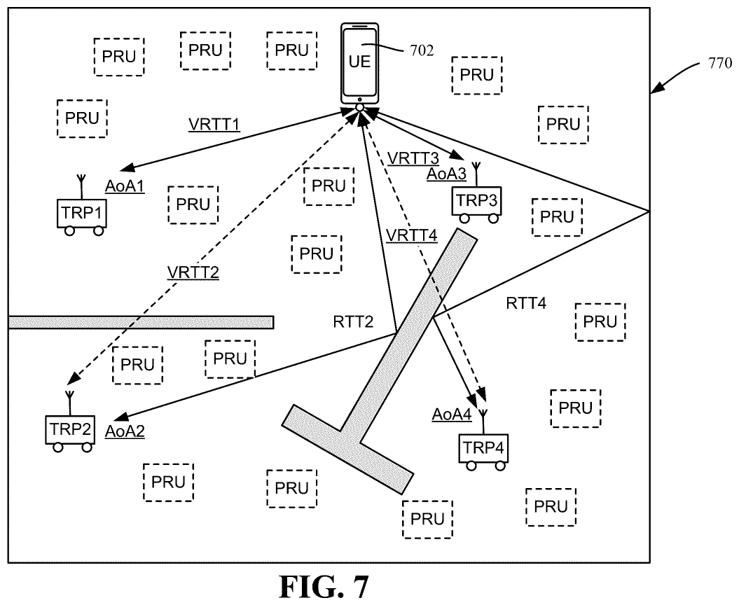

FIG. 7 shows an example deployment environment 770 having four transmit-receive points (TRP1-TRP4) (simplified relative to an eighteen transmit-receive point in one 3GPP indoor scenario) that depict the correction module's AI/ML model training and/or model usage. In FIG. 7, a signal from a UE 702 is received through two LOS and two NLOS links, which unless corrected as described herein, will cause two skewed RTT measurements. Because NLOS propagation distance is significantly longer than associated LOS-like virtual links, the position estimation without RTT correction suffers significantly; in contrast with RTT correction as described herein, there is no fundamental limitation to position estimation accuracy.

As is understood, in AI/ML model training, positioning reference unit device instances (PRUs, represented in FIG. 7 as dashed blocks) can be positioned and/or moved throughout a deployment environment, such as a factory setting, to provide round trip time and angle of arrival data for each TRP, based on the various PRU locations and each TRP location. A PRU acts as a UE with a benefit of a known location, enabling to link measurements to a label. Training other than with PRUs are alternatives, as described herein. The model, not explicitly shown in the example of FIG. 7, can be located outside of or within the environment 770, and in any event is trained with such collected datasets. In usage following training, the one or more PRUs need not be active and thus typically are not present, although their presence or absence is not significant unless retraining or refinement is needed.

In this example, consider that a realistic factory floor is moderately occupied with robots, shelves and other user equipment resulting in a various levels of propagation conditions, from line of sight to non-line of sight situations. With existing line of sight-dependent algorithms, positioning accuracy of the implementation is not consistent, due to ‘pockets’ of non-line of sight conditions spread across the factory.

Consider that in this example, following learning/training, a UE 702 such as a mobile internet of things (IoT) sensor or the like is within the deployment environment 770, and is located at an unknown location that needs to be determined, particularly if the UE 702 moves from time to time whereby physical measurement for this device location and likely many such devices) is not practical. In this example, as can be seen, RTT1, AoA1, RTT3 and AoA3 will be obtained based on line of sight communication links, while RTT2, AoA2, RTT4 and AoA4 will be obtained based on non-line of sight communication links, with angle of arrival data that result from surface reflections rather than line of sight signals. The solid lines represent the actual communication links between the transmit receive points TRP1-TRP4 to and from the UE 702, while the dashed lines represent the model-corrected non-line of sight communication links between the transmit receive points TRP2 and TRP4 to and from the UE 702.

As can be understood from FIG. 7, the non-line of sight propagation distances are significantly longer for non-line of sight links than for line of sight links, with different angles of arrival relative to the arrival angle data for straight line-of-sight links (e.g., which is determinable from the PRU coordinates). The propagation distances correspond to longer round trip times RTT2 and RTT4 for the non-line of sight communication links relative to the shorter round trip times RTT1 and RTT3. However, because the model was trained on both line of sight and non-line of sight propagation distances corresponding to round trip times and angle of arrival data, a sufficiently accurate location of the UE can be estimated by having the model correct the non-line of sight round trip times RTT2 and RTT4 into virtual round trip times VRTT2 and VRTT4, respectively; (as described herein, in inference the model does not differentiate between line of sight and non-line of sight links, only inputting measured round trip time data and angle of arrival data, whereby RTT1 and RTT3 are output as VRTT1 and VRTT3). Note that via the technology described herein, existing multi-RTT (at least three points for triangulation with two dimensions or four points with three dimension) algorithms that rely on line of sight conditions are thus not given the two skewed RTT measurements (the non-corrected values of RTT2 and RTT4), whereby if used, the position estimation would suffer significantly. Instead, the system described herein inserts the AI/ML correction model for each TRP before the multi-lateration) positioning algorithm. The measured round trip time values of RTT1-RTT4 along with their angle of arrival data AoA1-AoA4, are converted by the correction module to virtual round trip time values VRTT1-VRTT4, which result in an accurate location estimation by the positioning algorithm, including for non-line of sight conditions.

As can be seen in FIG. 4, the UE-TRP4 angle of arrival data AoA4 can be the same as or very close to the angle of arrival should there have been a line of sight communication link; however the measured the UE-TRP4 round trip time data RTT4 is significantly longer than the round trip time would be for a line of sight communication link the UE-TRP4. Thus, how much RTT correction is made depends more on the LOS versus non-LOS round trip time difference than on the angle of arrival difference. Similarly, it can be understood that (although not explicitly shown) a measured round trip time for a non-line of sight link can be close to what the round trip time for a line of sight link would be; however, the angle of arrival data would differ, and thus how much RTT correction is made depends more on the LOS versus non-LOS angle of arrival difference than on the LOS versus non-LOS RTT difference.

The AI/ML model for a given TRP captures unique properties of a planned deployment, meaning the model is trained on real measurements in the deployment environment as in FIG. 7, or based on a high-fidelity simulation of the environment. To this end, a training dataset (of RTT data, angle of arrival data) can be generated using one or a combination of the following techniques, including using positioning reference units (PRUs)/instances thereof as in FIG. 7 spread in the deployment area at known locations to collect round trip time data and angle of arrival data of communications between the PRUs and each of the transmit-receive points. The PRUs-based dataset spatial resolution can be refined further by employing semi-supervised learning.

In outdoor scenarios, instead of (or in addition to) PRUs, one or more training device instances in the form of UEs with GPS reporting can be used, potentially enabling to collect more detailed datasets from various locations in the outdoor environment. Digital twin simulations can be used for training, where a digital twin refers to a realistic simulation of a targeted space/area, which in addition to geometric properties also simulates true-to-reality physics of materials, resulting in close-to-realistic behavior.

Different AI/ML supervised learning solutions can be considered, depending on system requirements and platform capabilities. In the event the environment changes, reinforcement learning or retraining can be employed to maintain a model's relevance over time.

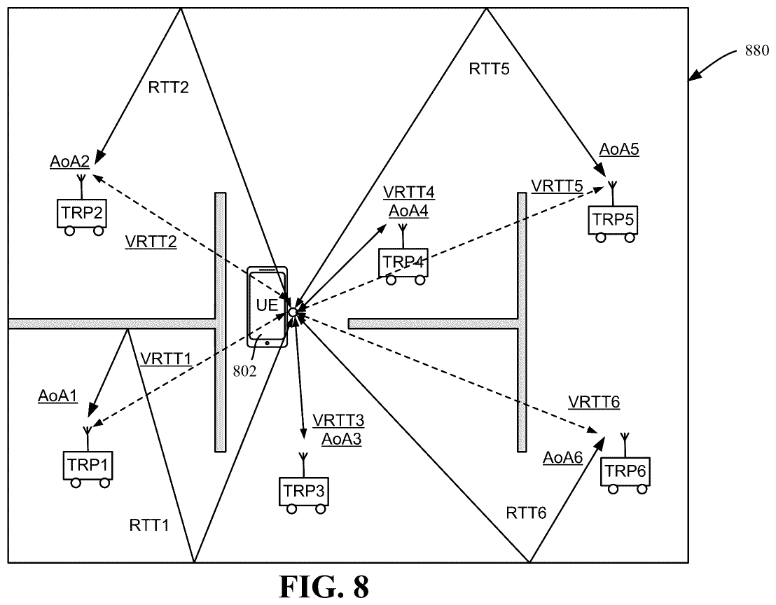

In another example shown in FIG. 8, six transmit-receive points (TRP1-TRP6) depict AI/ML model usage with respect to estimating the location of a user equipment 802. Although not explicitly shown, it is understood that training has already occurred similar to that described herein including with reference to FIG. 7, e.g., via a number of training devices at various locations in the environment 860. As can be seen, again the non-line of sight propagation distances are significantly longer than the line of sight links, corresponding to longer round trip times RTT1, RTT2, RTT5 and RTT6 for the non-line of sight communication links relative to the shorter round trip times RTT3 and RTT4.

As is understood, the deployment scenario in scenario has six TRPs TRP1-TRP6, with only two out of six TRP-UE links being of line of sight type. Without RTT correction, line of sight-based multi-RTT algorithm accuracy would be very poor. In contrast, with trained correction models, the position determination algorithm is able to utilize all six links without compromising on accuracy. Again, because the model was trained on both line of sight and non-line of sight propagation distances/round trip times and angles of arrival, a sufficiently accurate location of the UE 402 can be estimated by the model by processing the RTT1-RTT6 with angles of arrival AoA1-AoA 6, respectively, to virtual line of sight time values VRTT1-VRTT6.

The examples of FIGS. 7 and 8 can be understood to show how an existing deployment can be upgraded to improve positioning accuracy without full overhaul of the existing solution. Considering a hypothetical network deployment in an indoor factory, resembling a known 3GPP scenario with evenly distributed TRPs and in which the implemented positioning algorithm is a multi-RTT mechanism. The factory floor can be moderately occupied with robots, shelves and other equipment resulting in a various levels of propagation conditions, from LOS to NLOS, with up to double the propagation time measured for an NLOS communication link compared to a virtual (LOS-like) communication link. Positioning accuracy of the implementation is not consistent due to the NLOS conditions spread across the factory. Although a dedicated model needs to be trained for each TRP and each deployment, training with actual conditions is straightforward. Alternatively (or in addition to actual training), a dataset for initial training can be generated using a digital twin of the factory. In any scenario, the TRP-based models can be refined via training using PRUs spread throughout the factory, e.g., covering more densely the NLOS conditions that tend to impact positioning error the most. Each trained correction model, inserted before the multi-RTT positioning algorithm, is expected to improve positioning accuracy significantly as the correction model enables multi-RTT algorithm to perform at based on complete LOS conditions.

It is understood that whether indoor-based (e.g., PRU) or UE/outdoor-based training can be performed by any number of training device instances, which can be a single training device (e.g., UE or PRU) moved among multiple known locations, and/or multiple devices at multiple known locations. In training, each TRP collects the RTT data and angle of arrival data from the PRUs/UE at known locations, which serves as the training labels. In inference, the RTT and angle of arrival data of a UE at an unknown location is input to the model resulting in a VRTT value output, which becomes part of the VRTT vector dataset.

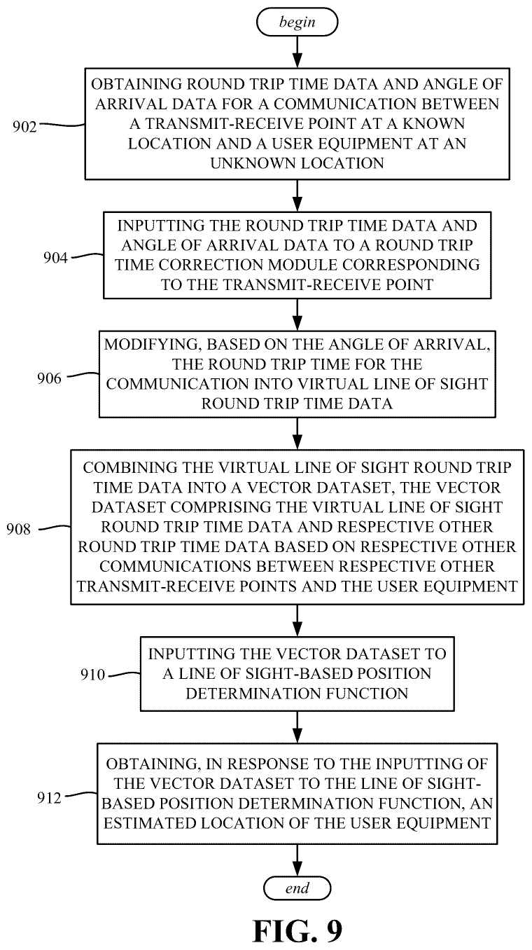

One or more aspects can be embodied in a system, such as represented in the example operations of FIG. 9, and for example can include a memory that stores computer executable components and/or operations, and a processor that executes computer executable components and/or operations stored in the memory. Example operations can include operation 902, which represents obtaining round trip time data and angle of arrival data for a communication between a transmit-receive point at a known location and a user equipment at an unknown location. Example operation 904 represents inputting the round trip time data and angle of arrival data to a round trip time correction module corresponding to the transmit-receive point. Example operation 906 represents modifying, based on the angle of arrival, the round trip time for the communication into virtual line of sight round trip time data. Example operation 908 represents combining the virtual line of sight round trip time data into a vector dataset, the vector dataset comprising the virtual line of sight round trip time data and respective other round trip time data based on respective other communications between respective other transmit-receive points and the user equipment. Example operation 910 represents inputting the vector dataset to a line of sight-based position determination function. Example operation 912 represents obtaining, in response to the inputting of the vector dataset to the line of sight-based position determination function, an estimated location of the user equipment.

The round trip time correction module can include a look-up table that relates the round trip time data and the angle of arrival data to round trip time-related correction data.

The round trip time correction module can include an analytical function that converts the round trip time data and the angle of arrival data to round trip time-related correction data.

The known location of the transmit-receive point can be a first known location, and the round trip time correction module can include a model trained with respective round trip time datasets and respective angle of arrival training datasets for respective communications between the transmit-receive point and a respective device instances at respective second known locations.

The respective device instances can include respective positioning reference unit instances located at the respective second known locations.

The respective device instances can include respective mobile device instances located at the respective second known locations and configured to report the respective second known locations via global positioning system data.

The transmit-receive point at the first known location and the respective device instances at the respective second known locations can be represented by a digital twin simulation of an environment, and the respective round trip time datasets and the respective angle of arrival training datasets can be based on the digital twin simulation.

The transmit-receive point and the respective other transmit-receive points can be spatially distributed in a deployment environment.

The transmit-receive point and the respective other transmit-receive points can be substantially evenly distributed.

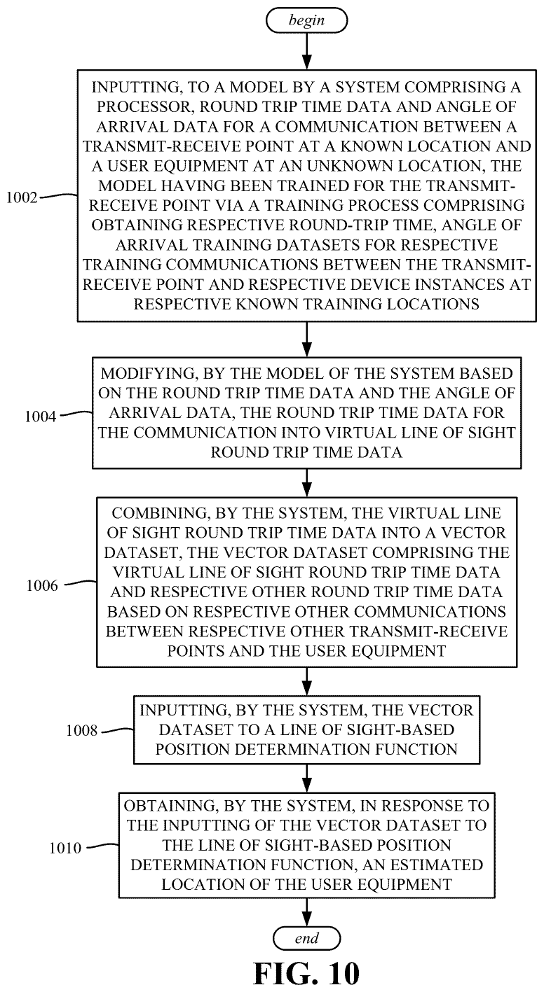

One or more example aspects, such as corresponding to example operations of a method, are represented in FIG. 10. Example operation 1002 represents inputting, to a model by a system including a processor, round trip time data and angle of arrival data for a communication between a transmit-receive point at a known location and a user equipment at an unknown location, the model having been trained for the transmit-receive point via a training process including obtaining respective round-trip time, angle of arrival training datasets for respective training communications between the transmit-receive point and respective device instances at respective known training locations. Example operation 1004 represents modifying, by the model of the system based on the round trip time data and the angle of arrival data, the round trip time data for the communication into virtual line of sight round trip time data. Example operation 1006 represents combining, by the system, the virtual line of sight round trip time data into a vector dataset, the vector dataset including the virtual line of sight round trip time data and respective other round trip time data based on respective other communications between respective other transmit-receive points and the user equipment. Example operation 1008 represents inputting, by the system, the vector dataset to a line of sight-based position determination function. Example operation 1010 represents obtaining, by the system, in response to the inputting of the vector dataset to the line of sight-based position determination function, an estimated location of the user equipment.

The vector dataset can include at least four virtual line of sight values corresponding to at least four transmit-receive points.

At least one of the respective device instances can include a positioning reference unit, and the training process further can include moving the positioning reference unit among at least two of the respective known training locations.

At least one of the respective device instances can include a mobile device that reports location coordinates, and the training process further can include moving the mobile device among at least two of the respective known training locations.

The model can be a first model, the round trip time data can be first round trip time data, the angle of arrival data can be first angle of arrival data for a first communication between a first transmit-receive point at a first known location and the user equipment, the training process can be a first training process including obtaining respective first round-trip time, angle of arrival training datasets for first respective training communications between the first transmit-receive point and first respective device instances at respective first known training locations, the virtual line of sight round trip time data can be first virtual line of sight round trip time data, the respective other transmit-receive points can include a second transmit receive point, and further operations can include inputting, by the system to a second model, second round trip time data and second angle of arrival data for a second communication between the second transmit-receive point at a second known location and the user equipment, the second model having been trained for the second transmit-receive point via a second training process including obtaining second respective round-trip time, angle of arrival training datasets for respective second training communications between the second transmit-receive point and second respective device instances at second respective known training locations, and modifying, by the second model of the system based on the second round trip time data and the second angle of arrival data, the second round trip time data for the second communication into second virtual line of sight round trip time data, wherein the other round trip time data can include the second virtual line of sight round trip time data.

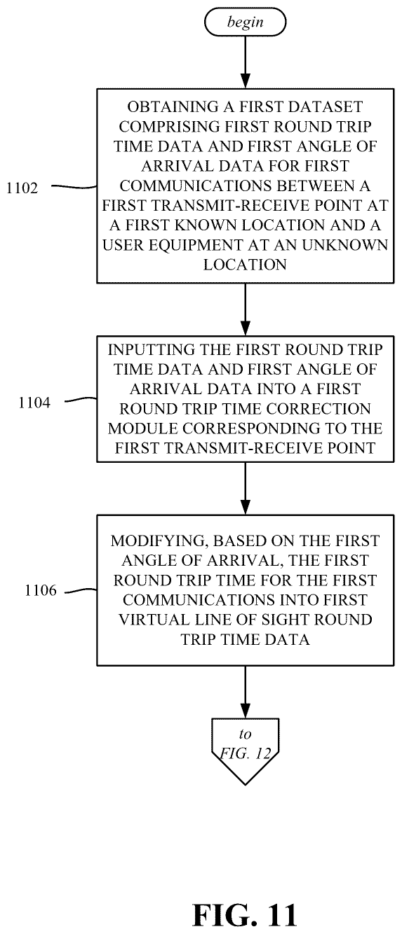

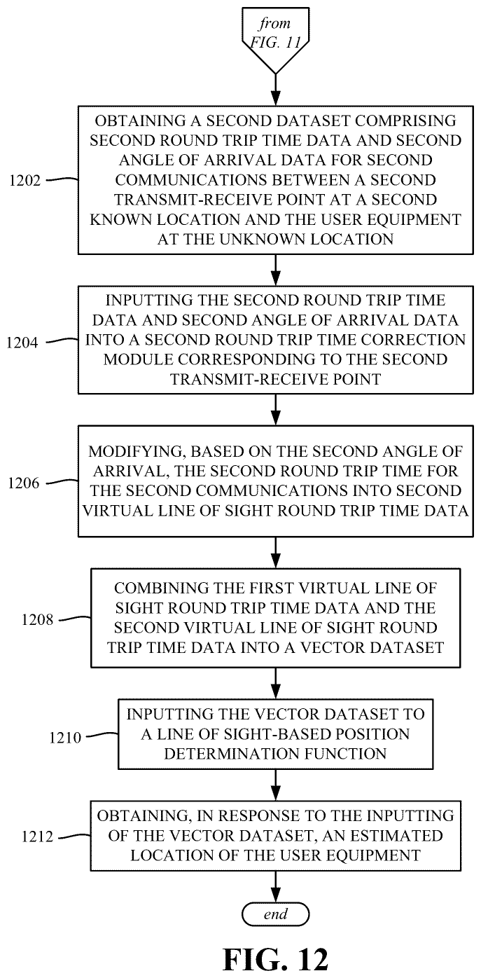

FIGS. 11 and 12 summarize various example operations, e.g., corresponding to a machine-readable medium, including executable instructions that, when executed by a processor, facilitate performance of operations. Example operation 1102 of FIG. 11 represents obtaining a first dataset including first round trip time data and first angle of arrival data for first communications between a first transmit-receive point at a first known location and a user equipment at an unknown location. Example operation 1104 represents inputting the first round trip time data and first angle of arrival data into a first round trip time correction module corresponding to the first transmit-receive point. Example operation 1106 represents modifying, based on the first angle of arrival, the first round trip time for the first communications into first virtual line of sight round trip time data. The operations continue at FIG. 12, in which example operation 1202 of FIG. 12 represents obtaining a second dataset including second round trip time data and second angle of arrival data for second communications between a second transmit-receive point at a second known location and the user equipment at the unknown location. Example operation 1204 represents inputting the second round trip time data and second angle of arrival data into a second round trip time correction module corresponding to the second transmit-receive point. Example operation 1206 represents modifying, based on the second angle of arrival, the second round trip time for the second communications into second virtual line of sight round trip time data. Example operation 1208 represents combining the first virtual line of sight round trip time data and the second virtual line of sight round trip time data into a vector dataset. Example operation 1210 represents inputting the vector dataset to a line of sight-based position determination function. Example operation 1212 represents obtaining, in response to the inputting of the vector dataset, an estimated location of the user equipment.

Further operations can include combining third round trip time data corresponding to a third communication with a third transmit-receive point into the vector dataset prior to the inputting of the vector dataset to the line of sight-based position determination function.

The first round trip time correction module can include at least one of: a look-up table that relates the first round trip time data and the first angle of arrival data to first round trip time-related correction data, or an analytical function that converts the first round trip time data and the first angle of arrival data to the first round trip time-related correction data.

The first round trip time correction module can include a model trained with respective round trip time, angle of arrival training datasets for respective communications between the first transmit-receive point and respective training device instances at respective training device instance locations.

The respective training device instances at the training third known locations can include at least one of: a positioning reference unit, or a mobile device.

Further operations can include obtaining a third dataset including third round trip time data and third angle of arrival data for third communications between a third transmit-receive point at a third known location and the user equipment at the unknown location, inputting the third round trip time data and third angle of arrival data into a third round trip time correction module corresponding to the third transmit-receive point, modifying, based on the third angle of arrival, the third round trip time for the third non-line of sight communications into third virtual line of sight round trip time data, combining the third virtual line of sight round trip time data into the vector dataset prior to the inputting of the vector dataset to the line of sight-based position determination function.

As can be seen, the technology described herein facilitates determination of a UE location by exploiting relations between a measured RTT data and angle of arrival data, including for line of sight and non-line of sight conditions to obtain virtual “LOS-like” round trip times. This is done without tight network synchronization requirements, that is, without the drawbacks of channel impulse response timing considerations (input variations and tight network synchronization requirements, although channel impulse response is not precluded from use as well), and without the drawbacks of only true line of sight conditions/requirements of existing multi-RTT algorithms.

Various types of correction models can be used, including an AI/ML model, which as described herein is less sensitive than existing direct AI/ML based approaches because of not being dependent on clock behavior, and which can be trained and used with a reduced set of input data relative to channel impulse response data. In addition, although TRP and deployment-specific, the reduced training input dimensions make it far more feasible to train a TRP's AI/ML correction model over a large number of expected scenarios, including in noisy RTT measurements, than could be practically done using the vast number of possible variations that can impact perceived channel impulse response data. The AI/ML correction model as described herein thus has reduced complexity relative to channel impulse response-based model. Still further, in usage of the model, there is reduced overhead of reporting from the TRPs' respective correction modules to the location management function, that is, only virtual RTT (VRTT) data from the TRPs are part of the vector dataset, instead of the full channel impulse response data. The location management function need not be aware of any RTT-to VRTT corrections that have been made.

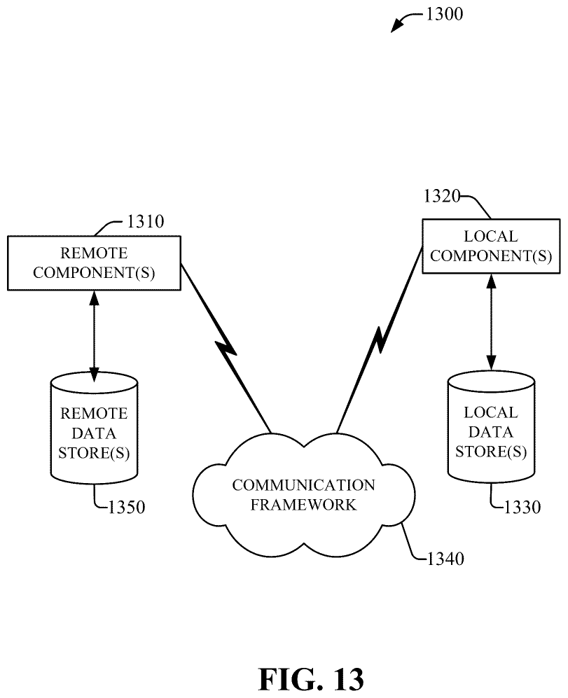

FIG. 13 is a schematic block diagram of a computing environment 1300 with which the disclosed subject matter can interact. The system 1300 comprises one or more remote component(s) 1310. The remote component(s) 1310 can be hardware and/or software (e.g., threads, processes, computing devices). In some embodiments, remote component(s) 1310 can be a distributed computer system, connected to a local automatic scaling component and/or programs that use the resources of a distributed computer system, via communication framework 1340. Communication framework 1340 can comprise wired network devices, wireless network devices, mobile devices, wearable devices, radio access network devices, gateway devices, femtocell devices, servers, etc.

The system 1300 also comprises one or more local component(s) 1320. The local component(s) 1320 can be hardware and/or software (e.g., threads, processes, computing devices). In some embodiments, local component(s) 1320 can comprise an automatic scaling component and/or programs that communicate/use the remote resources 1310, etc., connected to a remotely located distributed computing system via communication framework 1340.

One possible communication between a remote component(s) 1310 and a local component(s) 1320 can be in the form of a data packet adapted to be transmitted between two or more computer processes. Another possible communication between a remote component(s) 1310 and a local component(s) 1320 can be in the form of circuit-switched data adapted to be transmitted between two or more computer processes in radio time slots. The system 1300 comprises a communication framework 1340 that can be employed to facilitate communications between the remote component(s) 1310 and the local component(s) 1320, and can comprise an air interface, e.g., Uu interface of a UMTS network, via a long-term evolution (LTE) network, etc. Remote component(s) 1310 can be operably connected to one or more remote data store(s) 1350, such as a hard drive, solid state drive, SIM card, device memory, etc., that can be employed to store information on the remote component(s) 1310 side of communication framework 1340. Similarly, local component(s) 1320 can be operably connected to one or more local data store(s) 1330, that can be employed to store information on the local component(s) 1320 side of communication framework 1340.

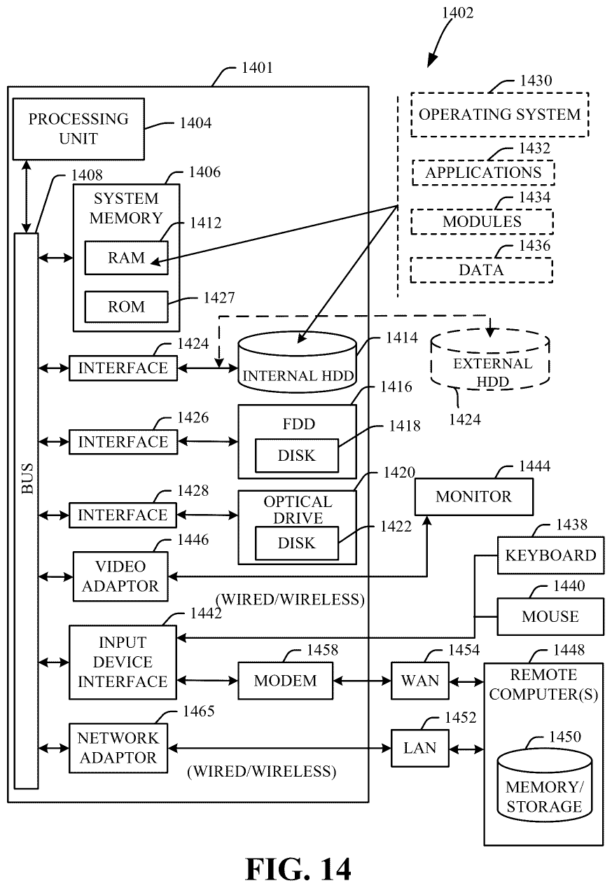

In order to provide additional context for various embodiments described herein, FIG. 14 and the following discussion are intended to provide a brief, general description of a suitable computing environment 1400 in which the various embodiments of the embodiment described herein can be implemented. While the embodiments have been described above in the general context of computer-executable instructions that can run on one or more computers, those skilled in the art will recognize that the embodiments can be also implemented in combination with other program modules and/or as a combination of hardware and software.

Generally, program modules include routines, programs, components, data structures, etc., that perform particular tasks or implement particular abstract data types. Moreover, those skilled in the art will appreciate that the methods can be practiced with other computer system configurations, including single-processor or multiprocessor computer systems, minicomputers, mainframe computers, Internet of Things (IoT) devices, distributed computing systems, as well as personal computers, hand-held computing devices, microprocessor-based or programmable consumer electronics, and the like, each of which can be operatively coupled to one or more associated devices.

The illustrated embodiments of the embodiments herein can be also practiced in distributed computing environments where certain tasks are performed by remote processing devices that are linked through a communications network. In a distributed computing environment, program modules can be located in both local and remote memory storage devices.

Computing devices typically include a variety of media, which can include computer-readable storage media, machine-readable storage media, and/or communications media, which two terms are used herein differently from one another as follows. Computer-readable storage media or machine-readable storage media can be any available storage media that can be accessed by the computer and includes both volatile and nonvolatile media, removable and non-removable media. By way of example, and not limitation, computer-readable storage media or machine-readable storage media can be implemented in connection with any method or technology for storage of information such as computer-readable or machine-readable instructions, program modules, structured data or unstructured data.

Computer-readable storage media can include, but are not limited to, random access memory (RAM), read only memory (ROM), electrically erasable programmable read only memory (EEPROM), flash memory or other memory technology, compact disk read only memory (CD-ROM), digital versatile disk (DVD), Blu-ray disc (BD) or other optical disk storage, magnetic cassettes, magnetic tape, magnetic disk storage or other magnetic storage devices, solid state drives or other solid state storage devices, or other tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and includes any information delivery or transport media. The term “modulated data signal” or signals refers to a signal that has one or more of its characteristics set or changed in such a manner as to encode information in one or more signals. By way of example, and not limitation, communication media include wired media, such as a wired network or direct-wired connection, and wireless media such as acoustic, RF, infrared and other wireless media.

With reference again to FIG. 14, the example environment 1400 for implementing various embodiments of the aspects described herein includes a computer 1402, the computer 1402 including a processing unit 1404, a system memory 1406 and a system bus 1408. The system bus 1408 couples system components including, but not limited to, the system memory 1406 to the processing unit 1404. The processing unit 1404 can be any of various commercially available processors. Dual microprocessors and other multi-processor architectures can also be employed as the processing unit 1404.

The system bus 1408 can be any of several types of bus structure that can further interconnect to a memory bus (with or without a memory controller), a peripheral bus, and a local bus using any of a variety of commercially available bus architectures. The system memory 1406 includes ROM 1410 and RAM 1412. A basic input/output system (BIOS) can be stored in a non-volatile memory such as ROM, erasable programmable read only memory (EPROM), EEPROM, which BIOS contains the basic routines that help to transfer information between elements within the computer 1402, such as during startup. The RAM 1412 can also include a high-speed RAM such as static RAM for caching data.

The computer 1402 further includes an internal hard disk drive (HDD) 1414 (e.g., EIDE, SATA), and can include one or more external storage devices 1416 (e.g., a magnetic floppy disk drive (FDD) 1416, a memory stick or flash drive reader, a memory card reader, etc.). While the internal HDD 1414 is illustrated as located within the computer 1402, the internal HDD 1414 can also be configured for external use in a suitable chassis (not shown). Additionally, while not shown in environment 1400, a solid state drive (SSD) could be used in addition to, or in place of, an HDD 1414.

Other internal or external storage can include at least one other storage device 1420 with storage media 1422 (e.g., a solid state storage device, a nonvolatile memory device, and/or an optical disk drive that can read or write from removable media such as a CD-ROM disc, a DVD, a BD, etc.). The external storage 1416 can be facilitated by a network virtual machine. The HDD 1414, external storage device(s) 1416 and storage device (e.g., drive) 1420 can be connected to the system bus 1408 by an HDD interface 1424, an external storage interface 1426 and a drive interface 1428, respectively.

The drives and their associated computer-readable storage media provide nonvolatile storage of data, data structures, computer-executable instructions, and so forth. For the computer 1402, the drives and storage media accommodate the storage of any data in a suitable digital format. Although the description of computer-readable storage media above refers to respective types of storage devices, it should be appreciated by those skilled in the art that other types of storage media which are readable by a computer, whether presently existing or developed in the future, could also be used in the example operating environment, and further, that any such storage media can contain computer-executable instructions for performing the methods described herein.

A number of program modules can be stored in the drives and RAM 1412, including an operating system 1430, one or more application programs 1432, other program modules 1434 and program data 1436. All or portions of the operating system, applications, modules, and/or data can also be cached in the RAM 1412. The systems and methods described herein can be implemented utilizing various commercially available operating systems or combinations of operating systems.

Computer 1402 can optionally comprise emulation technologies. For example, a hypervisor (not shown) or other intermediary can emulate a hardware environment for operating system 1430, and the emulated hardware can optionally be different from the hardware illustrated in FIG. 14. In such an embodiment, operating system 1430 can comprise one virtual machine (VM) of multiple VMs hosted at computer 1402. Furthermore, operating system 1430 can provide runtime environments, such as the Java runtime environment or the .NET framework, for applications 1432. Runtime environments are consistent execution environments that allow applications 1432 to run on any operating system that includes the runtime environment. Similarly, operating system 1430 can support containers, and applications 1432 can be in the form of containers, which are lightweight, standalone, executable packages of software that include, e.g., code, runtime, system tools, system libraries and settings for an application.

Further, computer 1402 can be enabled with a security module, such as a trusted processing module (TPM). For instance, with a TPM, boot components hash next in time boot components, and wait for a match of results to secured values, before loading a next boot component. This process can take place at any layer in the code execution stack of computer 1402, e.g., applied at the application execution level or at the operating system (OS) kernel level, thereby enabling security at any level of code execution.

A user can enter commands and information into the computer 1402 through one or more wired/wireless input devices, e.g., a keyboard 1438, a touch screen 1440, and a pointing device, such as a mouse 1442. Other input devices (not shown) can include a microphone, an infrared (IR) remote control, a radio frequency (RF) remote control, or other remote control, a joystick, a virtual reality controller and/or virtual reality headset, a game pad, a stylus pen, an image input device, e.g., camera(s), a gesture sensor input device, a vision movement sensor input device, an emotion or facial detection device, a biometric input device, e.g., fingerprint or iris scanner, or the like. These and other input devices are often connected to the processing unit 1404 through an input device interface 1444 that can be coupled to the system bus 1408, but can be connected by other interfaces, such as a parallel port, an IEEE 1494 serial port, a game port, a USB port, an IR interface, a BLUETOOTH® interface, etc.

A monitor 1446 or other type of display device can be also connected to the system bus 1408 via an interface, such as a video adapter 1448. In addition to the monitor 1446, a computer typically includes other peripheral output devices (not shown), such as speakers, printers, etc.

The computer 1402 can operate in a networked environment using logical connections via wired and/or wireless communications to one or more remote computers, such as a remote computer(s) 1450. The remote computer(s) 1450 can be a workstation, a server computer, a router, a personal computer, portable computer, microprocessor-based entertainment appliance, a peer device or other common network node, and typically includes many or all of the elements described relative to the computer 1402, although, for purposes of brevity, only a memory/storage device 1452 is illustrated. The logical connections depicted include wired/wireless connectivity to a local area network (LAN) 1454 and/or larger networks, e.g., a wide area network (WAN) 1456. Such LAN and WAN networking environments are commonplace in offices and companies, and facilitate enterprise-wide computer networks, such as intranets, all of which can connect to a global communications network, e.g., the Internet.

When used in a LAN networking environment, the computer 1402 can be connected to the local network 1454 through a wired and/or wireless communication network interface or adapter 1458. The adapter 1458 can facilitate wired or wireless communication to the LAN 1454, which can also include a wireless access point (AP) disposed thereon for communicating with the adapter 1458 in a wireless mode.

When used in a WAN networking environment, the computer 1402 can include a modem 1460 or can be connected to a communications server on the WAN 1456 via other means for establishing communications over the WAN 1456, such as by way of the Internet. The modem 1460, which can be internal or external and a wired or wireless device, can be connected to the system bus 1408 via the input device interface 1444. In a networked environment, program modules depicted relative to the computer 1402 or portions thereof, can be stored in the remote memory/storage device 1452. It will be appreciated that the network connections shown are examples and other means of establishing a communications link between the computers can be used.

When used in either a LAN or WAN networking environment, the computer 1402 can access cloud storage systems or other network-based storage systems in addition to, or in place of, external storage devices 1416 as described above. Generally, a connection between the computer 1402 and a cloud storage system can be established over a LAN 1454 or WAN 1456 e.g., by the adapter 1458 or modem 1460, respectively. Upon connecting the computer 1402 to an associated cloud storage system, the external storage interface 1426 can, with the aid of the adapter 1458 and/or modem 1460, manage storage provided by the cloud storage system as it would other types of external storage. For instance, the external storage interface 1426 can be configured to provide access to cloud storage sources as if those sources were physically connected to the computer 1402.

The computer 1402 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, store shelf, etc.), and telephone. This can include Wireless Fidelity (Wi-Fi) and BLUETOOTH® wireless technologies. Thus, the communication can be a predefined structure as with a conventional network or simply an ad hoc communication between at least two devices.

The above description of illustrated embodiments of the subject disclosure, comprising what is described in the Abstract, is not intended to be exhaustive or to limit the disclosed embodiments to the precise forms disclosed. While specific embodiments and examples are described herein for illustrative purposes, various modifications are possible that are considered within the scope of such embodiments and examples, as those skilled in the relevant art can recognize.

In this regard, while the disclosed subject matter has been described in connection with various embodiments and corresponding Figures, where applicable, it is to be understood that other similar embodiments can be used or modifications and additions can be made to the described embodiments for performing the same, similar, alternative, or substitute function of the disclosed subject matter without deviating therefrom. Therefore, the disclosed subject matter should not be limited to any single embodiment described herein, but rather should be construed in breadth and scope in accordance with the appended claims below.

As it employed in the subject specification, the term “processor” can refer to substantially any computing processing unit or device comprising, but not limited to comprising, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit, an application specific integrated circuit, a digital signal processor, a field programmable gate array, a programmable logic controller, a complex programmable logic device, a discrete gate or transistor logic, discrete hardware components, or any combination thereof designed to perform the functions described herein. Processors can exploit nano-scale architectures such as, but not limited to, molecular and quantum-dot based transistors, switches and gates, in order to optimize space usage or enhance performance of user equipment. A processor may also be implemented as a combination of computing processing units.

As used in this application, the terms “component,” “system,” “platform,” “layer,” “selector,” “interface,” and the like are intended to refer to a computer-related entity or an entity related to an operational apparatus with one or more specific functionalities, wherein the entity can be either hardware, a combination of hardware and software, software, or software in execution. As an example, a component may be, but is not limited to being, a process running on a processor, a processor, an object, an executable, a thread of execution, a program, and/or a computer. By way of illustration and not limitation, both an application running on a server and the server can be a component. One or more components may reside within a process and/or thread of execution and a component may be localized on one computer and/or distributed between two or more computers. In addition, these components can execute from various computer readable media having various data structures stored thereon. The components may communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which is operated by a software or a firmware application executed by a processor, wherein the processor can be internal or external to the apparatus and executes at least a part of the software or firmware application. As yet another example, a component can be an apparatus that provides specific functionality through electronic components without mechanical parts, the electronic components can comprise a processor therein to execute software or firmware that confers at least in part the functionality of the electronic components.

In addition, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances.

While the embodiments are susceptible to various modifications and alternative constructions, certain illustrated implementations thereof are shown in the drawings and have been described above in detail. It should be understood, however, that there is no intention to limit the various embodiments to the specific forms disclosed, but on the contrary, the intention is to cover all modifications, alternative constructions, and equivalents falling within the spirit and scope.

In addition to the various implementations described herein, it is to be understood that other similar implementations can be used or modifications and additions can be made to the described implementation(s) for performing the same or equivalent function of the corresponding implementation(s) without deviating therefrom. Still further, multiple processing chips or multiple devices can share the performance of one or more functions described herein, and similarly, storage can be effected across a plurality of devices. Accordingly, the various embodiments are not to be limited to any single implementation, but rather are to be construed in breadth, spirit and scope in accordance with the appended claims.

What is claimed is:

1. A system, comprising:
a processor; and
a memory that stores executable instructions that, when executed by the processor, facilitate performance of operations, the operations comprising:
obtaining round trip time data and angle of arrival data for a communication between a transmit-receive point at a known location and a user equipment at an unknown location;
inputting the round trip time data and angle of arrival data to a round trip time correction module corresponding to the transmit-receive point;
modifying, based on the angle of arrival, the round trip time for the communication into virtual line of sight round trip time data;
combining the virtual line of sight round trip time data into a vector dataset, the vector dataset comprising the virtual line of sight round trip time data and respective other round trip time data based on respective other communications between respective other transmit-receive points and the user equipment;
inputting the vector dataset to a line of sight-based position determination function; and
obtaining, in response to the inputting of the vector dataset to the line of sight-based position determination function, an estimated location of the user equipment.

2. The system of claim 1, wherein the round trip time correction module comprises a look-up table that relates the round trip time data and the angle of arrival data to round trip time-related correction data.

3. The system of claim 1, wherein the round trip time correction module comprises an analytical function that converts the round trip time data and the angle of arrival data to round trip time-related correction data.

4. The system of claim 1, wherein the known location of the transmit-receive point is a first known location, and wherein the round trip time correction module comprises a model trained with respective round trip time datasets and respective angle of arrival training datasets for respective communications between the transmit-receive point and a respective device instances at respective second known locations.

5. The system of claim 4, wherein the respective device instances comprise respective positioning reference unit instances located at the respective second known locations.

6. The system of claim 4, wherein the respective device instances comprise respective mobile device instances located at the respective second known locations and configured to report the respective second known locations via global positioning system data.

7. The system of claim 4, wherein the transmit-receive point at the first known location and the respective device instances at the respective second known locations are represented by a digital twin simulation of an environment, and wherein the respective round trip time datasets and the respective angle of arrival training datasets are based on the digital twin simulation.

8. The system of claim 1, wherein the transmit-receive point and the respective other transmit-receive points are spatially distributed in a deployment environment.

9. The system of claim 8, wherein the transmit-receive point and the respective other transmit-receive points are substantially evenly distributed.

10. A method, comprising:
inputting, to a model by a system comprising a processor, round trip time data and angle of arrival data for a communication between a transmit-receive point at a known location and a user equipment at an unknown location, the model having been trained for the transmit-receive point via a training process comprising obtaining respective round-trip time, angle of arrival training datasets for respective training communications between the transmit-receive point and respective device instances at respective known training locations;
modifying, by the model of the system based on the round trip time data and the angle of arrival data, the round trip time data for the communication into virtual line of sight round trip time data;
combining, by the system, the virtual line of sight round trip time data into a vector dataset, the vector dataset comprising the virtual line of sight round trip time data and respective other round trip time data based on respective other communications between respective other transmit-receive points and the user equipment;
inputting, by the system, the vector dataset to a line of sight-based position determination function; and
obtaining, by the system, in response to the inputting of the vector dataset to the line of sight-based position determination function, an estimated location of the user equipment.

11. The method of claim 10, wherein the vector dataset comprises at least four virtual line of sight values corresponding to at least four transmit-receive points.

12. The method of claim 10, wherein at least one of the respective device instances comprises a positioning reference unit, and wherein the training process further comprises moving the positioning reference unit among at least two of the respective known training locations.

13. The method of claim 10, wherein at least one of the respective device instances comprises a mobile device that reports location coordinates, and wherein the training process further comprises moving the mobile device among at least two of the respective known training locations.

14. The method of claim 10, wherein the model is a first model, wherein the round trip time data is first round trip time data, wherein the angle of arrival data is first angle of arrival data for a first communication between a first transmit-receive point at a first known location and the user equipment, wherein the training process is a first training process comprising obtaining respective first round-trip time, angle of arrival training datasets for first respective training communications between the first transmit-receive point and first respective device instances at respective first known training locations, wherein the virtual line of sight round trip time data is first virtual line of sight round trip time data, wherein the respective other transmit-receive points comprise a second transmit receive point, and further comprising:
inputting, by the system to a second model, second round trip time data and second angle of arrival data for a second communication between the second transmit-receive point at a second known location and the user equipment, the second model having been trained for the second transmit-receive point via a second training process comprising obtaining second respective round-trip time, angle of arrival training datasets for respective second training communications between the second transmit-receive point and second respective device instances at second respective known training locations; and
modifying, by the second model of the system based on the second round trip time data and the second angle of arrival data, the second round trip time data for the second communication into second virtual line of sight round trip time data, wherein the other round trip time data comprises the second virtual line of sight round trip time data.

15. A non-transitory machine-readable medium, comprising executable instructions that, when executed by a processor, facilitate performance of operations, the operations comprising:
obtaining a first dataset comprising first round trip time data and first angle of arrival data for first communications between a first transmit-receive point at a first known location and a user equipment at an unknown location;
inputting the first round trip time data and first angle of arrival data into a first round trip time correction module corresponding to the first transmit-receive point;
modifying, based on the first angle of arrival, the first round trip time for the first communications into first virtual line of sight round trip time data;
obtaining a second dataset comprising second round trip time data and second angle of arrival data for second communications between a second transmit-receive point at a second known location and the user equipment at the unknown location;
inputting the second round trip time data and second angle of arrival data into a second round trip time correction module corresponding to the second transmit-receive point;
modifying, based on the second angle of arrival, the second round trip time for the second communications into second virtual line of sight round trip time data;
combining the first virtual line of sight round trip time data and the second virtual line of sight round trip time data into a vector dataset;
inputting the vector dataset to a line of sight-based position determination function; and
obtaining, in response to the inputting of the vector dataset, an estimated location of the user equipment.

16. The non-transitory machine-readable medium of claim 15, wherein the operations further comprise combining third round trip time data corresponding to third communications with a third transmit-receive point into the vector dataset prior to the inputting of the vector dataset to the line of sight-based position determination function.

17. The non-transitory machine-readable medium of claim 15, wherein the first round trip time correction module comprises at least one of: a look-up table that relates the first round trip time data and the first angle of arrival data to first round trip time-related correction data, or an analytical function that converts the first round trip time data and the first angle of arrival data to the first round trip time-related correction data.

18. The non-transitory machine-readable medium of claim 15, wherein the first round trip time correction module comprises a model trained with respective round trip time, angle of arrival training datasets for respective communications between the first transmit-receive point and respective training device instances at respective training device instance locations.

19. The non-transitory machine-readable medium of claim 18, wherein the respective training device instances at the training third known locations comprise at least one of: a positioning reference unit, or a mobile device.

20. The non-transitory machine-readable medium of claim 15, wherein the operations further comprise:
obtaining a third dataset comprising third round trip time data and third angle of arrival data for third communications between a third transmit-receive point at a third known location and the user equipment at the unknown location;
inputting the third round trip time data and third angle of arrival data into a third round trip time correction module corresponding to the third transmit-receive point;
modifying, based on the third angle of arrival, the third round trip time for the third communications into third virtual line of sight round trip time data; and
combining the third virtual line of sight round trip time data into the vector dataset prior to the inputting of the vector dataset to the line of sight-based position determination function.
